(19) United States
(12) Patent Application Publication
(10) Pub. No.: US 2015/0379728 A1
(43) Pub. Date: Dec. 31, 2015

(54) METHOD FOR GENERATING A MOTION FIELD FOR A VIDEO SEQUENCE

(71) Applicant: THOMSON LICENSING, Issy-les-Moulineaux (FR)

(72) Inventors: Pierre-Henri CONZE, Rennes (FR); Philippe ROBERT, Rennes (FR); Tomas CRIVELLI, Buenos Aires (AR); Luce MORIN, Rennes (FR)

(21) Appl. No.: 14/765,811

(22) PCT Filed: Feb. 4, 2014
(86) PCT No.: PCT/EP2014/052164

§ 371 Date: Aug. 4, 2015

(30) Foreign Application Priority Data
Feb. 5, 2013 (EP) 13305139.1
Jul. 25, 2013 (EP) 13306076.4

(51) Int. Cl. G06T 7/20; H04N 19/537; H04N 19/577; H04N 19/52; H04N 19/56

(52) U.S. Cl. CPC G06T 7/2033; H04N 19/52; H04N 19/56; H04N 19/577; H04N 19/537; G06T 2207/10016; G06T 2207/20016; G06T 2207/20032

(57) ABSTRACT

A method for generating a motion field between a current frame and a reference frame belonging to a video sequence from an input set of motion fields is disclosed. An motion field is associated to an ordered pair of frames comprises for a group of pixels belonging to a first frame of the ordered pair of frames, a motion vector computed from a location of the pixel in the first frame to an endpoint in a second frame of the ordered pair of frames. The method comprises determining a plurality of motion paths from a current frame to a reference frame wherein a motion path comprises a random sequence of N ordered pairs of frames associated to the input set of motion fields; N is an integer. The method then comprises determining, for the group of pixels belonging to the current frame, a plurality of candidate motion vectors from the current frame to the reference frame wherein a candidate motion vector is the result of a sum of motion vectors; each motion vector belonging to a motion field associated to an ordered pair of frames according to a determined motion path. And the method then comprises selecting, for the group of pixels belonging to the current frame, a motion vector among the plurality of candidate motion vectors.

### TECHNICAL FIELD

The present invention relates generally to the field of dense point matching in a video sequence. More precisely, the invention relates to a method for generating a motion field from a current frame to a reference frame belonging to a video sequence from an input set of motion fields.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

The invention concerns the estimation of dense point correspondences between two frames of a video sequence. This task is complex and a lot of methods have been proposed. There is no perfect estimator able to match any pair of frames. State-of-the-art methods have various strengths and weaknesses with respect to accuracy and robustness, and their respective quality also depend on the video content (image content, type and value of motion . . . ). In particular, the presence of large displacements is a limiting factor of the performance of the estimators, often making the motion estimation between distant frames difficult.

It is relevant to notice that there are numerous motion estimators with different intrinsic characteristics that lead to a performance that comparatively vary according to image content. From this remark, a solution consists in applying different estimators to produce various motion fields between two input frames and then deriving a final motion field by merging all these input motion fields. For example, the method described in the paper “FusionFlow: Discrete-Continuous Optimization for Optical Flow Estimation” by V. Lempitsky, S. Roth and C. Rother in IEEE Transactions on Computer Vision and Pattern Recognition 2008 or in the paper “Fusion moves for Markov random field optimization” by same othors in IEEE Transactions on Pattern Analysis and Machine Intelligence 2010, can be a solution to merge the motion fields pair by pair up to obtain a final motion field. A pixel-wise selection among this large set of dense motion fields is carried out based on an intrinsic vector quality (matching cost) and a spatial regularization. Theoretically, this technique allows one to combine all the benefits of the strategies mentioned above. Nevertheless, the matching can remain inaccurate for difficult cases such as: illumination variations, large motion, occlusions, zoom, non-rigid deformations, low color contrast between different motion regions, transparency, large uniform areas. The problem occurs frequently when the estimation is applied to distant frames.

Numerous applications require motion estimation between distant frames. This is particularly the case when the application requires referring to a small set of key frames, the other frames refer to. This includes video compression, semi-automatic video processing where an operator applies changes to key frames that must then be propagated to the other frames using motion compensation. For example, consider the task of modifying several images of a video sequence. It would be a tedious task to consistently modify all the frames manually. So it would be useful to automatically propagate these changes to the other frames taking into account the point correspondences between these frames and the key frame.

The invention applies to distant frames, called a current frame and a reference frame, in a sequence but can address motion estimation between any pair of frames and is particularly adapted to pairs for which classical motion estimators have a high error rate.

Concerning distant frames, motion estimation can be obtained through concatenation of elementary optical flow fields. These elementary optical flow fields can be computed between consecutive frames or for example skipping each other frame. However, this strategy is very sensitive to motion errors as one erroneous motion vector is enough to make the concatenated motion vector wrong. It becomes very critical in particular when concatenation involves a high number of elementary vectors.

A solution, described in the international patent application PCT/EP13/050870, addresses motion estimation between a reference frame and each of the other frames in a video sequence. The reference frame is for example the first frame of the video sequence. The solution consists in sequential motion estimation between the reference frame and the current frame, this current frame being successively the frame adjacent to the reference frame, then the next one and so on. The method relies on various input elementary motion fields that are supposed to be available. These motion fields link pairs of frames in the sequence with good quality as inter-frame motion range is supposed to be compatible with the motion estimator performance. The current motion field estimation between the current frame and the reference frame relies on previously estimated motion fields (between the reference frame and frames preceding the current one) and elementary motion fields that link the current frame to the previous processed frames: various motion candidates are built by concatenating elementary motion fields and previous estimated motion fields. Then, these various candidate fields are merged to form the current output motion field. This method is a good sequential option but cannot avoid possible drifts in some pixels. Then, once an error is introduced in a motion field, it can be propagated to the next fields during the sequential processing.

An alternative consists in performing a direct matching between the considered distant frames. However, the motion range is generally very large and estimation can be very sensitive to ambiguous correspondences, like for instance, within periodic image patterns. The method described in in the international patent application PCT/EP13/050870 has been shown much better than this alternative.

In order to avoid the problems above mentioned, we propose a method that relies on a new statistical fusion phase of multiple independent motion candidates that are built via concatenation.

### SUMMARY OF INVENTION

The invention is directed to a method for generating a motion field between a current frame and a reference frame belonging to a video sequence from an input set of elementary motion fields. A motion field associated to an ordered pair of frames (Iₐ and I_{b}) comprises for a group of pixels (xₐ) belonging to a first frame (Iₐ) of the ordered pair of frames, a motion vector (d_{a,b}(xₐ)) computed from the pixel (xₐ) in the first frame to an endpoint in a second frame (I_{b}) of the ordered pair of frames. The method is remarkable in that it comprises steps for:
determining a plurality of motion paths from a current frame (Iₐ) to a reference frame (I_{b}) wherein a motion path comprises a sequence of N ordered pairs of frames associated to the input set of motion fields; a first frame of an ordered pair corresponds to a second frame of the previous ordered pair in the sequence; the first image of the first ordered pair is the current frame (Iₐ); the second frame of the last ordered pair is the reference frame (I_{b}); and wherein N is an integer;
determining, for the group of pixels (xₐ) belonging to the current frame (Iₐ), a plurality of candidate motion vectors from the current frame (Iₐ) to the reference frame (I_{b}) wherein a candidate motion vector is the result of a sum of motion vectors; each motion vector belonging to a motion field associated to an ordered pair of frames according to a determined motion path;
selecting, for the group of pixels (xₐ) belonging to the current frame (Iₐ), a motion vector among the plurality of candidate motion vectors.

According to a further advantageous characteristic of motion path determination, the number N of ordered pairs of frames in determined motion paths is smaller than a threshold N_{c}. According to another further advantageous characteristic, the number N is variable; therefore 2 motion paths have or do not have the same number of concatenated motion vectors.

According to another further advantageous characteristic, the N ordered pairs of frames in determined motion paths are randomly selected so as to achieve independent motion paths.

According to another further advantageous characteristic the second frame of the previous ordered pair in the sequence is temporally placed before or after the first frame of the ordered pair.

According to another further advantageous characteristic, the first frame of an ordered pair is temporally placed before the current frame or after the reference frame, thus allowing concatenating motion paths from frames outside of the video sequence comprised between the current frame and the reference frame.

According to an advantageous characteristic of motion path selection, the selection comprises minimizing a metric for the selected motion vector among the plurality of candidate motion vectors.

In a first embodiment, the metric comprises the Euclidian distance between candidate endpoints location.

In a second embodiment, the metric comprises Euclidian distance between color gain vectors. Indeed color gain vectors are defined in any color space known by the skilled in the art such as RGB color space or LAB color space. A candidate endpoint location results from a candidate motion vector. Color gain vectors are computed between color vectors of a local neighborhood of the candidate endpoint location and color vectors of a local neighborhood of the current pixel belonging to the current frame.

According to a further advantageous characteristic of the first embodiment, the selection comprises for each determined candidate motion vector, a) computing each Euclidian distance between a candidate endpoint location resulting from the determined candidate motion vector and each of other candidate endpoints location resulting from other candidate motion vectors; b) for each determined candidate motion vector, computing a median for the computed Euclidian distances; and c) selecting the motion vector for which the median of computed Euclidian distance is the smallest.

According to another further advantageous characteristic of the first embodiment, between step a) and step b), a step further comprises, for each determined candidate motion vector, counting the Euclidian distance a number of time representative of a confidence score of the candidate endpoint location resulting from the determined candidate motion vector.

According to a further advantageous characteristic of the motion path selection, candidate motion vectors from the reference frame to the current frame are generated as the candidate motion vectors from the current frame (Iₐ) to the reference frame according to the disclosed method, and each of candidate motion vectors for a pixel of reference frame is then used to define a new candidate motion vector between the current frame and the reference frame by identifying an endpoint of the vector in the current frame and by assigning inverted the candidate motion vector to the closest pixel in the current frame. Thus an inconsistency value is computed for a candidate motion vector for a current pixel in the current frame by comparing a distance between an endpoint location of the candidate motion vector and endpoint locations of the inverted vectors of the current pixel when the candidate motion vector is not inverted, or by comparing a distance between an endpoint location of the candidate motion vector and endpoint locations of the non-inverted vectors of the current pixel when the candidate motion vector is inverted, and by selecting the smallest distance as the inconsistency value. The inconsistency value is used to define the confidence score of the candidate endpoint location.

According to a further advantageous characteristic of the second embodiment, the selection comprises d) for each determined candidate motion vector, computing Euclidian distance between color gain vectors of a local neighborhood of candidate endpoint location and color gain vectors of a local neighborhood current pixel of a current frame, a candidate endpoint resulting from the determined candidate motion vector; e) for each determined candidate motion vector, computing a median for the computed color gain vectors; and f) selecting the motion vector for which the median is the smallest.

According to another further advantageous characteristic of the first embodiment, between step d) and step e), a step further comprises, for each determined candidate motion vector, counting the Euclidian distance between color gain vectors a number of time representative of a confidence score of candidate endpoint location resulting from the determined candidate motion vector.

According to a first variant of motion path selection, selecting step c) or f) are repeated on a subset of determined candidate motion vectors resulting in a subset of motion vectors for which the median are the smallest. The selection is then followed by a global optimization process on the subset of motion vectors in order to select for each current pixel of the current frame the best vector with respect to minimization of a global energy.

According to second variant of motion path selection, selecting step c) or f) further comprises selecting P motion vectors for which the median is the smallest, P being an integer. The selection is then followed by a global optimization process on a subset of P motion vectors in order to select for each pixel of the current frame the best vector with respect to minimization of a global energy.

According to any of the variants of motion path selection, the global optimization process comprises the use of gain in matching cost of global energy, use of inconsistency value in a data cost of global energy, use of gain in a regularization of global energy.

According to another further advantageous characteristic the steps of the method are repeated for a plurality of current frame belonging to the video sequence/to the neighbouring of reference frame. Then, the global optimization process further comprises use of temporal smoothing in global energy.

According to another further advantageous, the generated motion field is used as input set of motion field for iteratively generating a motion field.

A device for generating a set of motion fields comprising a processor configured to:
determine a plurality of motion paths from a current frame (Iₐ) to a reference frame (I_{b}) wherein a motion path comprises a sequence of N ordered pairs of frames associated to the input set of motion fields; a first frame of an ordered pair corresponds to a second frame of the previous ordered pair in the sequence; the first image of the first ordered pair is the current frame (Iₐ); the second frame of the last ordered pair is the reference frame (I_{b}); and wherein N is an integer;
determine, for the group of pixels (xₐ) belonging to the current frame (Iₐ), a plurality of candidate motion vectors from the current frame (Iₐ) to the reference frame (I_{b}) wherein a candidate motion vector is the result of a sum of motion vectors; each motion vector belonging to a motion field associated to an ordered pair of frames according to a determined motion path;
select, for the group of pixels (xₐ) belonging to the current frame (Iₐ), a motion vector among the plurality of candidate motion vectors.

A device for generating a set of motion fields comprising:
means for determining a plurality of motion paths from a current frame (Iₐ) to a reference frame (I_{b}) wherein a motion path comprises a sequence of N ordered pairs of frames associated to the input set of motion fields; a first frame of an ordered pair corresponds to a second frame of the previous ordered pair in the sequence; the first image of the first ordered pair is the current frame (Iₐ); the second frame of the last ordered pair is the reference frame (I_{b}); and wherein N is an integer;
means for determining, for the group of pixels (xₐ) belonging to the current frame (Iₐ), a plurality of candidate motion vectors from the current frame (Iₐ) to the reference frame (I_{b}) wherein a candidate motion vector is the result of a sum of motion vectors; each motion vector belonging to a motion field associated to an ordered pair of frames according to a determined motion path;
means for selecting, for the group of pixels (xₐ) belonging to the current frame (Iₐ), a motion vector among the plurality of candidate motion vectors.

Any characteristic or variant described for the method is compatible with a device intended to process the disclosed methods.

A computer program product comprising program code instructions to execute of the steps of the method according to any of claims 1 to 18 when this program is executed on a computer.

A processor readable medium having stored therein instructions for causing a processor to perform at least the steps of the method according to any of claims 1 to 18.

### BRIEF DESCRIPTION OF DRAWINGS

Preferred features of the present invention will now be described, by way of non-limiting example, with reference to the accompanying drawings, in which:

FIG. 1a illustrates steps of the method according to a preferred embodiment for motion estimation between distant frames;

FIG. 1b illustrates steps of the method according to a refinement of the preferred embodiment for motion estimation between distant frames;

FIG. 2 illustrates an example of the point position distribution;

FIG. 3a illustrates the construction of motion vector candidates for a given pixel of a reference frame with respect to another reference frame wherein each motion candidate is obtained by concatenating elementary input vectors with various step values;

FIG. 3b illustrates the construction of motion vector candidates for a given pixel of a reference frame with respect to another reference frame wherein each motion candidate is obtained by concatenating forward and backward elementary input vectors with various step values;

FIG. 3c illustrates the construction of motion vector candidates for a given pixel of a reference frame with respect to another reference frame wherein each motion candidate is obtained by concatenating forward and backward elementary input vectors with various step values and wherein some motion fields may link frames located outside the interval delimited by the reference frames;

FIG. 4 illustrates an exhaustive generation of step sequences;

FIG. 5 illustrates the construction of the four possible motion paths between I₀ and I₃ with frame steps 1, 2 and 3;

FIG. 6 illustrates a device for generating a set of motion fields according to a particular embodiment of the invention;

FIG. 7 represents the generation of multiple motion candidates;

FIG. 8 represents the displacement field d*_{ref,n} by considering for each pixel x_{ref} of I_{ref} the following candidate positions in Iₙ: candidates coming from neighbouring frames, the K initial candidates, a candidate obtained via d*_{n,ref} inverted; and

FIG. 9 represents a matching cost and Euclidean distances ed_{n,m} and ed_{m,n} defined with respect to each temporal neighbouring candidate x*ₘ and involved in the proposed energy. These three terms act as strong temporal smoothness constraints.

### DESCRIPTION OF EMBODIMENTS

A salient idea of the method for generating a set of motion fields for a video sequence is to propose an advantageous sequential method of combining motion fields to produce a long term matching through an exhaustive search of paths of motion vector. A complementary idea of the method for generating a set of motion fields for a video sequence is to select a motion vector among a large number of candidate motion vector, not only on cost matching but through statistical distribution in term of spatial location or color gain of candidate motion vectors.

Thus the invention concerns two main subjects namely motion estimation between frames Iₐ and I_{b}, from the set S of motion candidates and construction of the motion candidates (set S) for motion estimation between frames Iₐ and I_{b}. These two subjects are described below in two separate sub-sections.

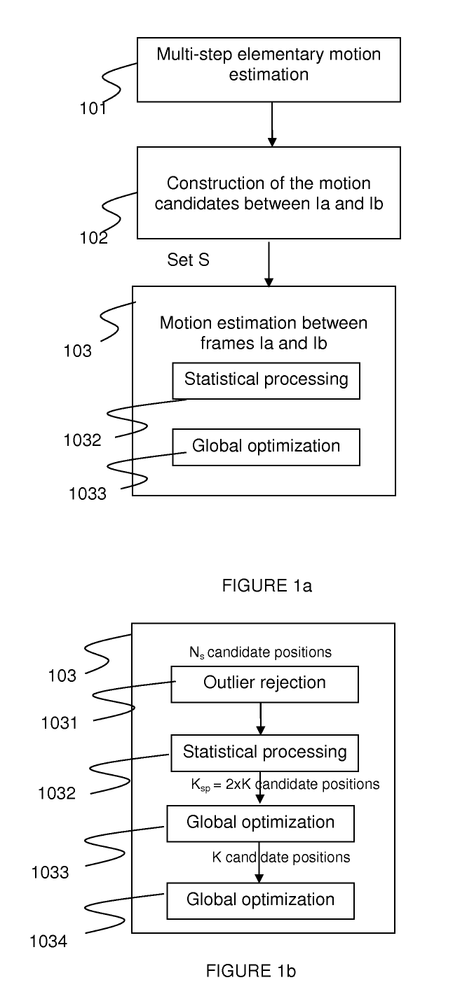

FIG. 1a illustrates steps of the method according to a preferred embodiment for motion estimation between distant frames via combinatorial multi-step integration and statistical selection. In a preliminary step 101, multi-step elementary motion estimations are performed to generate the set of input motion fields. In a first step 102, the motion candidates between frames Iₐ and I_{b} are constructed using determined motion paths. In a second step 103, a motion field is estimated through a selection process among motion candidates.

Motion Estimation Between Two Frames from an Input Set of Motion Candidates

### Context

Let Iₐ and I_{b} be two frames of a given video sequence. The goal is to obtain very accurate forward (from pixels of Iₐ to positions in I_{b}) and backward (from pixels of I_{b} to positions in Iₐ) motion fields between these two frames. Let S_{a,b} and S_{b,a} be respectively, the large sets of forward and backward dense motion fields.

For each pixel xₐ (resp. x_{b}) of frame Iₐ (resp. I_{b}), the forward (resp. backward) dense motion fields in S_{a,b} (resp. in S_{b,a}) give a large set of candidate positions in frame I_{b} (resp. Iₐ). This set of candidate positions is defined as S_{a,b}(xₐ) (resp. S_{b,a}(x_{b})) in the following. The proposed processing aims at selecting the best correspondences by exploiting the statistical nature of the available information and the intrinsic candidate quality. Moreover, spatial regularization is considered through a global optimization technique.

### Input Fields

Backward (resp. forward) motion fields in S_{b,a} (resp. S_{a,b}) can be reversed into forward (resp. backward) motion fields. The resulting motion fields are included into set S_{a,b} (resp. S_{b,a}). For instance, backward motion fields from pixels of frame I_{b} are back-projected into frame Iₐ. For each one, we identify the nearest pixel of the arrival position in frame Iₐ. Finally, the corresponding displacement vector from I_{b} to Iₐ is reversed and assigned to this nearest pixel. This gives a new forward motion vector which is added into S_{a,b}(xₐ).

In the following, the proposed statistical processing 1032 and optimization 1033 technique are separately described. Then, we present the whole optimal candidate position selection framework and explains how both are combined.

### First Metric Embodiment: Optimal Candidate Position Selection Based on Statistics

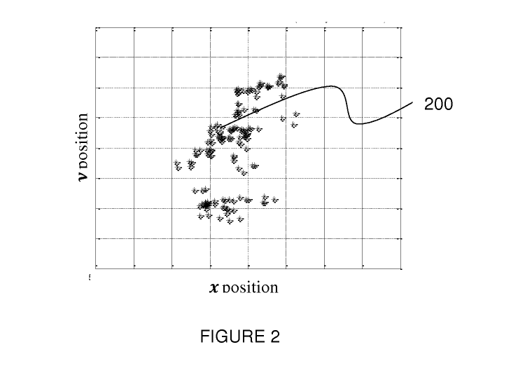

Let S_{a,b}(xₐ)={x_{b}ⁿ}_{n∈[[0, . . . , K-1]]} be the set of candidate positions x_{b}ⁿ (i.e. candidate correspondences) in frame I_{b} for pixel xₐ of frame Iₐ. K corresponds to the cardinal of S_{a,b}(xₐ). The goal is to find the optimal candidate position x* within S_{a,b}(xₐ), i.e. the best position of xₐ in frame I_{b}, by exploiting the statistical information extracted from the sample distribution of the candidate point positions and the quality values assigned to each candidate vector. FIG. 2 illustrates an example of the point position distribution. FIG. 2 depicts the distribution in frame I_{b} of the endpoints of the vectors attached to pixel xₐ. The proposed selection exploits the statistical information on the point position distribution and the quality values assigned to each candidate vector. The optimal candidate position x* 200 belongs to the set S_{a,b}(xₐ) of candidate positions.

The underlying idea is to assume a Gaussian model for the distribution of the position samples, and try to find the its central value, which is then considered as the position estimation x*. Consequently, we suppose that the position candidates in S_{a,b}(xₐ) follow a Gaussian probability density with mean μ and variance σ². The probability density function of x_{b}ⁿ is thus given by:

$$π ( {x}_{b}^{n} \vert μ , {σ}^{2} ) = {( 2 π {σ}^{2} )}^{- 1 / 2} {e}^{[ - \frac{1}{2} {( \frac{{x}_{b}^{n} - μ}{σ} )}^{2} ]} \qquad ( 1 )$$

Supposing that all the candidate positions x_{b}ⁿ are independent, the probability density function of S_{a,b}(xₐ) is written as follows:

$$π ( {S}_{a , b} ( {x}_{A} ) \vert μ , {σ}^{2} ) = {\prod }_{n = 0}^{K - 1} {( 2 π {σ}^{2} )}^{- 1 / 2} {e}^{[ - \frac{1}{2} {( \frac{{x}_{b}^{n} - μ}{σ} )}^{2} ]} \qquad ( 2 )$$

The maximum likelihood estimator (MLE) of the mean μ and variance σ² is obtained from maximizing equation (3).

$$ln ( π ( {S}_{a , b} ( {x}_{a} ) \vert μ , {σ}^{2} ) ) = - K \cdot ln ( 2 π {σ}^{2} ) - \frac{1}{2 {σ}^{2}} {\sum }_{n = 0}^{K - 1} {( {x}_{b}^{n} - μ )}^{2} \qquad ( 3 )$$

We are interested in the central value, which in the case of a Gaussian distribution coincides with the mean value, the median value and the mode. Thus we seek for estimating μ, regardless of the value of σ² Furthermore, we impose that the estimator must be one of the elements of S_{a,b}(xₐ). The optimal candidate position equals

$${x}^{*} = arg {min}_{{x}_{b}^{n} ∈ {S}_{a , b} ( {x}_{a} )} {\sum }_{{j = 0}_{j \neq n}}^{K - 1} {( {x}_{b}^{j} - {x}_{b}^{n} )}^{2} \qquad ( 4 )$$

The assumption of Gaussianity can be largely perturbed by erroneous position samples, called outliers. Consequently, a robust estimation of the distribution central value is necessary. For this sake, the mean operator is replaced by the median operator. The estimate becomes:

$${x}^{*} = arg {min}_{{x}_{b}^{n} ∈ {S}_{a , b} ( {x}_{a} )} ( {med}_{j \neq n} ( {‖ {x}_{b}^{j} - {x}_{b}^{n} ‖}_{2}^{2} ) ) \qquad ( 5 )$$

Finally, each candidate position x_{b}ⁿ receives a corresponding quality score Q(x_{b}ⁿ) computed using an inconsistency value Inc(x_{b}ⁿ), as described in the following. Inconsistency concerns a vector (e.g. d_{a,b}ⁿ) assigned to a pixel (e.g. xₐ). It is then noted either Inc(xₐ, d_{a,b}ⁿ) or Inc(x_{b}ⁿ) referring to the endpoint of vector d_{a,b}ⁿ assigned to pixel xₐ (x_{b}ⁿ=xₐ+d_{a,b}ⁿ). More precisely, the inconsistency value assigned to each candidate x_{b}ⁿ corresponds to the inconsistency of the corresponding motion vector d_{a,b}ⁿ(xₐ), i.e. the motion vector which has been used to obtain x_{b}ⁿ. Inconsistency values can be computed in different manners:

In a first variant, as described in equation (6), the inconsistency value Inc(xₐ, d_{a,b}) can be obtained similarly to left/right checking (LRC) described in the case of stereo vision but applied to forward/backward displacement fields. Thus, we compute the Euclidean distance between the starting point xₐ in frame Iₐ and the end position of the backward displacement fields d_{b,a} starting from (xₐ+d_{a,b}(xₐ))in frame I_{b}.

Inc(xₐ,d_{a,b})=∥d_{a,b}(xₐ)+d_{b,a}(xₐ+d_{a,b}(xₐ))∥₂ (6)

In a second variant, instead of considering the backward displacement fields d_{b,a} starting from the nearest pixel (np) of xₐ−d_{a,b}(xₐ) in frame I_{b}, an alternative consists in taking into account all the backward displacement vectors in d_{b,a} for which the ending point in frame Iₐ, has xₐ as nearest pixel. In practice, this backward motion field has been transformed into forward motion field by inversion and added to the set of forward motion fields S_{a,b}(xₐ) as described previously. In other words, the second variant consists in computing the Euclidean distance from the current candidate position x_{b}ⁿ and the nearest candidate position of the distribution which has been obtained through this procedure of back-projection and inversion.

Once inconsistency values have been computed, a quality score, here denoted as Q(x_{b}ⁿ), is defined for each candidate position x_{b}ⁿ. Q(x_{b}ⁿ) is computed as follows: the maximum and minimum values of Inc(x_{b}ⁿ) among all candidates are mapped, respectively, to 0 and a predefined integer value Qₘₐₓ. Intermediate inconsistency values are then mapped to the line defined by these two values and the result is rounded to the nearest integer value. Then, Q(x_{b}ⁿ) ∈ [0, . . . , Qₘₐₓ]. In this manner, the higher Q(x_{b}ⁿ) is, the smaller the inconsistency Inc(x_{b}ⁿ). We aim at favoring high quality candidate positions in the computation of the estimate x*. In practice, Q(x_{b}ⁿ) is used as a voting mechanism: while computing the intervening medians in equation (5), each sample x_{b}^{j} is considered Q(x_{b}^{j}) times to set the occurrence of elements ∥x_{b}^{j}−x_{b}ⁿ∥₂². A robust estimate towards the high quality candidates is thus introduced, which enforces the forward-backward motion consistency.

This statistical processing is applied to each pixel of Iₐ independently. In addition, it is necessary to include a spatial regularization in order to strive for motion spatial consistency in frame Iₐ.

### Second Metric Embodiment: Gain Factor in Candidate Position Selection Based on Statistics

The same minimization procedure can be applied on color gain in order to guide the selection to a candidate position which exhibits a gain similarity with a large number of candidate positions within the distribution. Color gain g_{a,b} of pixel xₐ is a 3-component vector (g_{a,b}=(g_{a,b}^{r},g_{a,b}^{g},g_{a,b}^{b})^{T} for R, G, B components) that relates color of this pixel in frame Iₐ and color of the corresponding point moved at location (xₐ+d_{a,b}(xₐ)) in frame I_{b} as follows:

Iₐ^{c}(xₐ)=g_{a,b}^{c}(xₐ)·I_{b}^{c}(xₐ+d_{a,b}(xₐ)) (7)

Index c refers to one of the 3 color components. The gain can be estimated for example via known correlation methods during motion estimation. A color gain vector can be obtained by applying such methods to each color channel C_{R}, C_{G}, C_{B}, leading to a gain factor for each of these channels. The estimation of the gain of a given pixel involves a block of pixels (e.g. 3×3) centered on the pixel.

For the statistical processing, we use the symmetric formula that introduces the gain of point (xₐ+d_{a,b}(xₐ)) in frame I_{b} as follows:

I_{b}^{c}(xₐ+d_{a,b}(xₐ))=g_{b,a}^{c}(xₐ+d_{a,b}(xₐ))·Iₐ^{c}(xₐ) (8)

Replacing the position criterion in equation (5) by a gain criterion, the median operator becomes:

$${x}^{*} = arg {min}_{{x}_{b}^{n} ∈ {S}_{a , b} ( {x}_{a} )} ( {med}_{j \neq n} ( {‖ {ℊ}_{b , a} ( {x}_{b}^{j} ) - {ℊ}_{b , a} ( {x}_{b}^{n} ) ‖}_{2}^{2} ) ) \qquad ( 9 )$$

Furthermore, it is possible to consider both locations and gains of the motion candidates in the statistical processing using the following equation:

$${x}^{*} = arg {min}_{{x}_{b}^{n} ∈ {S}_{a , b} ( {x}_{a} )} ( {med}_{j \neq n} ( {‖ {x}_{b}^{j} - {x}_{b}^{n} ‖}_{2}^{2} + δ \cdot {‖ {ℊ}_{b , a} ( {x}_{b}^{j} ) - {ℊ}_{b , a} ( {x}_{b}^{n} ) ‖}_{2}^{2} ) ) \qquad ( 10 )$$

Scalar δ allows adjusting weight of gain-based component with respect to position-based component.

### Optimal Candidate Position Selection Framework

We propose to combine statistical processing per pixel and a global candidate selection process to include simultaneously:
information about the candidate position distribution,
robust gain compensated color matching and motion inconsistency,
spatial regularization defined with respect to motion and gain similarity.

The statistical processing precedes the application of the global optimization process. Two variants have been considered to form the framework combining statistical processing per pixel and global optimization and will be described in more details in FIG. 2b.

Thus, according to a first variant of candidate position selection, the set S_{a,b}(xₐ) of candidate positions x_{b}ⁿ is divided randomly into different equally sized subsets. The statistical processing is applied for each subset in order to select the best candidate position per subset. Then, our global optimization approach merges the obtained candidates in order to finally select the optimal one x*.

According to a second variant of candidate position selection, the statistical processing is applied to the whole set S_{a,b}(xₐ). Then, the P best candidate positions of the distribution are selected from median minimization, as described in (5). Then, our global optimization approach fuses these P candidate positions in order to finally select the optimal one x*.

We describe now the energy we have defined for global optimization. We consider set R_{a,b}(xₐ) of candidate positions coming from the previous selection process.

### Global Optimization Method

It consists in performing a global optimization stage that fuses candidate positions in R_{a,b}(xₐ) into a single optimal one. We consider R_{a,b}(xₐ)={x_{b}ⁿ}_{n∈[[0, . . . , K-1]]} as the set of K candidate positions x_{b}ⁿ in frame I_{b} for pixel xₐ of frame Iₐ. We introduce L={lₓ_{_{A}}} as a complete labeling of frame Iₐ where each label indicates one of the candidate positions. In practice, for a given xₐ, each label accounts for both a displacement field and a gain

$$( {d}_{a , b}^{{l}_{{x}_{a}}} , {g}_{a , b}^{{l}_{{x}_{a}}} ) .$$

The data term for each pixel is denoted as

$${C}_{a , b}^{g} ( {x}_{a} , {d}_{a , b}^{{l}_{{x}_{a}}} ) ,$$

a gain-compensated color matching cost between grid position xₐ in frame Iₐ and position

$${x}_{a} , {d}_{a , b}^{{l}_{{x}_{a}}}$$

in frame I_{b} as described in equation (11)

$${C}_{a , b}^{ℊ} ( {x}_{a} , {d}_{a , b}^{{l}_{{x}_{a}}} ) = {\sum }_{c ∈ \{ r , ℊ , b \}} {‖ {I}_{a}^{c} ( {x}_{a} ) - {ℊ}_{a , b}^{c , {l}_{{x}_{a}}} ( {x}_{a} ) \cdot {I}_{b}^{c} ( {x}_{a} + {d}_{a , b}^{{l}_{{x}_{a}}} ( {x}_{a} ) ) ‖}_{1} \qquad ( 11 )$$

Moreover, inconsistency is introduced in the data cost to make it more robust. It is computed via one of the variants mentioned above. Scalar γ_{d} allows adjusting weight of inconsistency with respect to matching cost.

Furthermore, smoothness is imposed by considering that two neighboring pixels should take similar motion values, as one expects for the majority of the points inside a moving scene element (objects, backgrounds, textures). A first possibility would be to favor the situation where both pixels take the same candidate label. This can be done, for instance, by considering a classical discrete interaction as the Potts model. However, equal labels thus not imply that motion vectors are forcedly similar as, for each pixel, the candidates were generated independently. A better solution is to favor directly the similarity on the motion vectors by introducing the following function to be minimized

$${E}_{a , b} ( L ) = {\sum }_{{x}_{a}} {ρ}_{d} ( {C}_{a , b}^{ℊ} ( {x}_{a} , {d}_{a , b}^{{l}_{{x}_{a}}} ) + {γ}_{d} \cdot Inc ( {x}_{a} , {d}_{a , b}^{{l}_{{x}_{a}}} ) ) + {\sum }_{〈 {x}_{a} , {y}_{a} 〉} {α}_{{x}_{a} , {y}_{a}} \cdot {ρ}_{r} ( {‖ {d}_{a , b}^{{l}_{{x}_{a}}} - {d}_{a , b}^{{l}_{{y}_{a}}} ‖}_{1} ) + {\sum }_{〈 {x}_{a} , {y}_{a} 〉} {β}_{{x}_{a} , {y}_{a}} \cdot {ρ}_{r} ( {‖ {ℊ}_{a , b}^{{l}_{{x}_{a}}} - {ℊ}_{a , b}^{{l}_{{y}_{a}}} ‖}_{1} ) \qquad ( 12 )$$

where the spatial regularization term involves both motion and gain comparisons with neighboring positions according to the 8-nearest-neighbor neighborhood. αₓ_{ₐ}_{,y}_{ₐ} accounts for local color spatial similarities in frame Iₐ whereas βₓ_{ₐ}_{,y}_{ₐ} is used to adjust the relative importance of each term in the minimization. The minimization is performed by the method of fusion move as presented by V. Lempitsky et al. Functions ρ_{d} and ρᵣ are respectively the Geman-McClure robust penalty function and the negative log of a Student-t distribution as in the paper “FusionFlow: Discrete-Continuous Optimization for Optical Flow Estimation”. This method gives the optimal position x* for each grid position xₐ (respectively x_{b}) of frame Iₐ (respectively I_{b}) while taking into account a spatial regularization based on motion and gain similarity. However, its application to a large set of candidate positions is limited by the computational load. The statistical processing preceding this global optimization process allows selecting a subset of good candidates.

The whole framework is applied from Iₐ to I_{b} and then from I_{b} to Iₐ. Finally, we obtain very accurate forward and backward dense motion fields between these two frames.

FIG. 1b illustrates rafinement in the motion estimation generation 103. As in previous embodiment, the statistical processing step 1032 is able to select the best candidate positions within a large distribution of candidate positions using criteria based on spatial density and intrinsic candidate quality. As in previous embodiment, a global optimization step 1033 fuses candidate motion fields by pairs following the approach of Lempitsky et al in the article entitled “FusionFlow: Discrete-continuous optimization for optical flow estimation” published CVPR 2008. In this rafinement, let I_{ref} and Iₙ be respectively the reference frame and the current frame of a given video sequence.

Regading another variant of candidate position selection in step 1032, for each x_{ref} ∈ I_{ref} we select among the large distribution T_{ref,n}(x_{ref}Kₛₚ=2×K candidate positions through statistical processing. Then, in a step 1033, we randomly group by pairs these Kₛₚ candidates in order to choose the K best candidates x̅ₙ^{k} ∀k ∈ [[0, . . . , K−1]] via global optimization. Finally, in a step 1034, this same global optimization method is used in order to fuse these K best candidates to obtain an optimal one: x*ₙ. In other words, these two last steps give the candidate displacement fields d̅_{ref,n} ∀k ∈ [[1, . . . , K−1]] and finally d*_{ref,n}, the optimal one.

For first pairs or in the case of temporary occlusion, the statistical selection is not adapted due to the small amount of candidates. Therefore, between 1 and K candidate positions, we do not perform any selection and all the candidates are kept. Between K+1 and Kₛₚ candidates, we use only the global optimization method up to obtain the K best candidate fields. If the number of candidates exceeds Kₛₚ, the statistical processing and the global optimization method are applied as explained above.

Another variant of candidate position selection in step 1032 provides further focus to inconsistency reduction. The idea is to strongly encourage the selection of from-the-reference motion vectors (i.e. between I_{ref} and Iₙ) which are consistent with to-the-reference motion vectors (i.e. between Iₙ and I_{ref}). Thus, the inconsistency assigned to a candidate motion vector d_{ref,n}ⁱ(x_{ref}) with i ∈ [[0, . . . , Kₓ_{_{ref}}−1]] and therefore to its corresponding candidate position xₙⁱ=x_{ref}+d_{ref,n}ⁱ(x_{ref}) corresponds to the euclidean distance between the nearest reverse (resp. direct) candidate among the distribution if xₙⁱ is direct (resp. reverse). We assign a quality score Q(xₙⁱ) to each candidate xₙⁱ of the distribution of candidates based on its inconsistency value and in using this quality score into the selection task reminded in equation (13) in order to promote candidates located in the neighbourhood of high quality candidates.

$${x}_{n}^{*} = arg {min}_{{x}_{n}^{i}} {med}_{j \neq i} {\sum }_{1 = 1}^{Q ( {x}_{n}^{j} )} {‖ {x}_{n}^{j} - {x}_{n}^{i} ‖}_{2}^{2} \qquad ( 13 )$$

However, inconsistencies may still remain and we propose to enforce consistency with stronger constraints. The proposed constraints are as follow. First, only input multi-step elementary optical flow vectors which are considered as consistent according to their inconsistency masks can be used to generate motion paths between I_{f} and Iₙ. Second, we introduce an outlier removal step 1031 before the statistical selection. This step consists in ordering all the candidates of the distribution with respect to their inconsistency values. Then, a percentage of R_{%} bad candidates is removed and the selection is performed on the remaining candidates. Third, at the end of the combinatorial integration and the selection procedure between I_{ref} and Iₙ, the optimal displacement field d*_{ref,n} is incorporated into the processing between Iₙ and I_{ref} which aims at enforcing the motion consistency between from-the-reference and to-the-reference displacement fields.

The proposed initial motion candidates generation is applied for both directions: from I_{ref} to Iₙ in order to obtain K initial from-the-reference candidate displacement fields as described above and then, from Iₙ to I_{ref} where an exactly similar processing leads to K initial to-the-reference candidate displacement fields. All the pairs {I_{ref},Iₙ} are processed through this way. Only N_{c}, the maximum number of concatenations, changes with respect to the temporal distance between the considered frames. In practice, we determine N_{c} with equation (14). This function, built empirically, is a good compromise between a too large number of concatenations which leads to large propagation errors and the opposite situation which limits the effectiveness of the statistical processing due to an insignificant total number of candidate positions.

$${N}_{c} ( n ) = \{ \begin{matrix}\vert n - ref \vert if \vert n - ref \vert \leq 5 \\ {α}_{0} \cdot log 10 ( {α}_{1} \cdot \vert n - ref \vert ) otherwise\end{matrix} \qquad ( 14 )$$

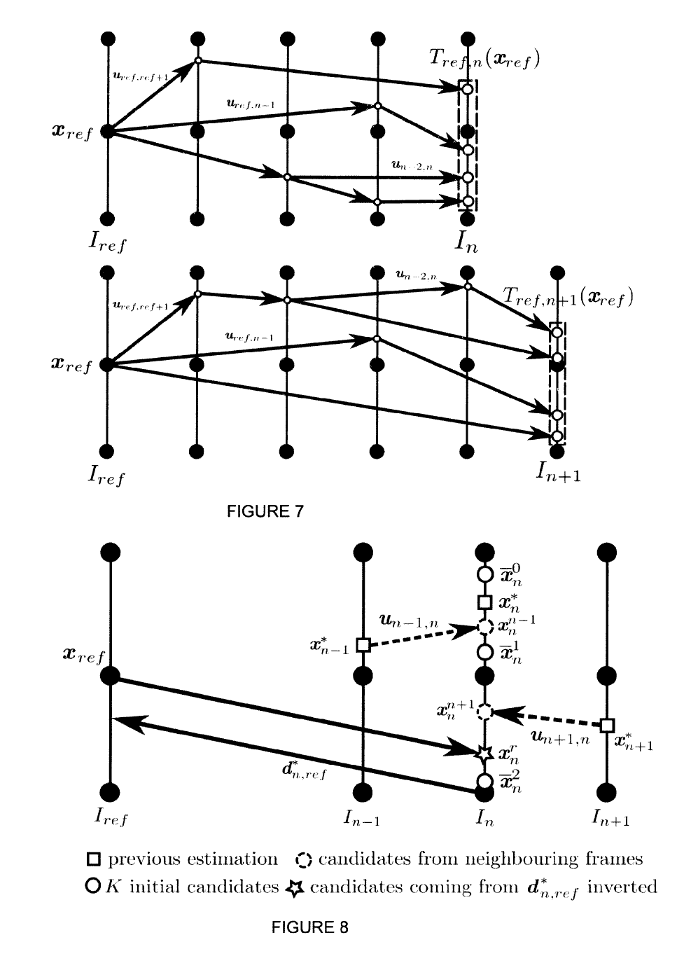

The guided-random selection which selects for each pair of frames {I_{ref},Iₙ} one part of all the possible motion paths limits the correlation between candidates respectively estimated for neighbouring frames. This avoids the situation in which a single estimation error is propagated and therefore badly influences the whole trajectory. The example given on FIG. 7 shows the motion paths selected by the guided-random selection for the pairs {I_{ref},Iₙ} and {I_{ref},Iₙ₊₁}. We can notice that
motion paths between I_{ref} and Iₙ₊₁ are not highly correlated with those between I_{ref} and Iₙ, and
the sets of elementary optical flow vectors involved in both cases are disjoined except concerning v_{ref,ref+1} and v_{ref,n-1} which are then concatenated with different vectors,
v_{n-2,n} contributes for both cases but the considered vectors do not start from the same position.
   These key considerations about the statistical independence of the resulting displacement fields are not addressed by state-of-the-art methods for which a strong temporal correlation is generally inescapable.

Once the initial motion candidates have been generated, we aim at iteratively refining the estimated displacement fields. The idea is to question the matching between each pixel x_{ref} (resp. xₙ) of I_{ref} (resp. Iₙ) and the candidate position x*ₙ (resp. x*_{ref}) in Iₙ (resp. I_{ref}) established during the previous iteration or during the initial motion candidates generation phase if the current iteration is the first one.

We propose to compare the previous estimate x*ₙ (resp. x*_{ref}) with respect to one part of all the following other candidate positions described in FIG. 8. First, we consider the K initial candidate positions x̅ₙ^{k} (resp. x̅_{ref}^{k}) ∀k ∈ [[1, . . . , K−1]] obtained during the initial motion candidates generation phase.

Moreover, we take into account a candidate position coming from the previous estimation of d*_{n,ref} (resp. d*_{ref,n}) which is inverted to obtain xₙ^{r} (resp. x_{ref}^{r}), as illustrated in FIG. 8 in the preferred embodiment when we use both approaches: from-the-reference and to-the-reference.

Regarding the global optimization step 1034, we introduce temporal smoothing by considering previously estimated motion fields for neighbouring frames to construct new input candidates. Let w be the temporal window. Between I_{ref} and Iₙ for instance, we use the elementary optical flow fields v_{m,n} between Iₘ and Iₙ with

$$m ∈ 〚 n - \frac{w}{2} , … , n + \frac{w}{2} 〛$$

and m≠n to obtain from x*ₘ ∈ Iₘ the new candidate xₙ^{m} in Iₙ. Conversely, to join I_{ref} from Iₙ, the elementary optical flow fields v_{n,m} are concatenated to the optimal displacement fields d*_{m,ref} computed during the previous iteration.

Instead of considering the candidates coming from all the frames of the spatial window, we can:
keep only the candidates whose intrinsic quality (matching cost, inconsistency . . . ) is above a threshold,
order the candidates with respect to their intrinsic quality and select the K_c best ones.

New candidates can be obtained through:
interpolation using candidates from neighbouring frames. For instance, considering a temporal window of size 3:

$${x}_{n}^{interp} = \frac{{x}_{n - 1}^{*} + {x}_{n + 1}^{*}}{2}$$

extrapolation using candidates from a set of previous/next frames.

We perform a global optimization method in order to fuse the previously described set of candidates into a single optimal displacement field, as done in Lempitsky et al., in the paper entitled “Fusion moves for Markov random field optimization”. For this task, a new energy has been built and two formulations are proposed depending on the type (from-the-reference or to-the-reference) of the displacement fields to be refined.

In the from-the-reference case, we introduce L={Iₓ_{_{ref}}} as a labeling of pixels x_{ref} of I_{ref} where each label indicates

$${x}_{n}^{{1}_{{x}_{ref}}} ,$$

one of the candidates listed above. Let

$${d}_{ref , n}^{{1}_{{x}_{ref}}}$$

be the corresponding motion vectors. We define the following energy in equation (15) and we use the fusion moves algorithm described by Lempitsky et al. in the two publications mentioned earlier to minimize it:

$${E}_{ref , n} ( L ) = {E}_{ref , n}^{d} ( L ) + {E}_{ref , n}^{r} ( L ) = {\sum }_{{x}_{ref}} {ρ}_{d} ( {ɛ}_{ref , n}^{d} ) + {\sum }_{{x}_{ref} , {y}_{ref}} {α}_{{x}_{ref} , {y}_{ref}} {ρ}_{r} ( {‖ {d}_{ref , n}^{{1}_{{x}_{ref}}} ( {x}_{ref} ) - {d}_{ref , n}^{{1}_{{y}_{ref}}} ( {y}_{ref} ) ‖}_{1} ) \qquad ( 15 )$$

The data term E_{ref,n}^{d}, described with more details in equation (16), involves the matching cost

$$C ( {x}_{ref} , {d}_{ref , n}^{{1}_{{x}_{ref}}} )$$

and the inconsistency value

$$Inc ( {x}_{ref} , {d}_{ref , n}^{{1}_{{x}_{ref}}} )$$

with respect to

$${d}_{ref , n}^{{1}_{{x}_{ref}}}$$

as described earlier. In addition, we propose to introduce strong temporal smoothness constraints into the energy formulation in order to efficiently guide the motion refinement.

$${ɛ}_{ref , n}^{d} = C ( {x}_{ref} , {d}_{ref , n}^{{1}_{{x}_{ref}}} ( {x}_{ref} ) ) + Inc ( {x}_{ref} , {d}_{ref , n}^{{1}_{{x}_{ref}}} ( {x}_{ref} ) ) + {\sum }_{{m = n - \frac{w}{2}}_{m \neq n}}^{n + \frac{w}{2}} C ( {x}_{n}^{{1}_{{x}_{ref}}} , {x}_{m}^{*} - {x}_{n}^{{1}_{{x}_{ref}}} ) + {ed}_{m , n} + {ed}_{n , m} \qquad ( 16 )$$

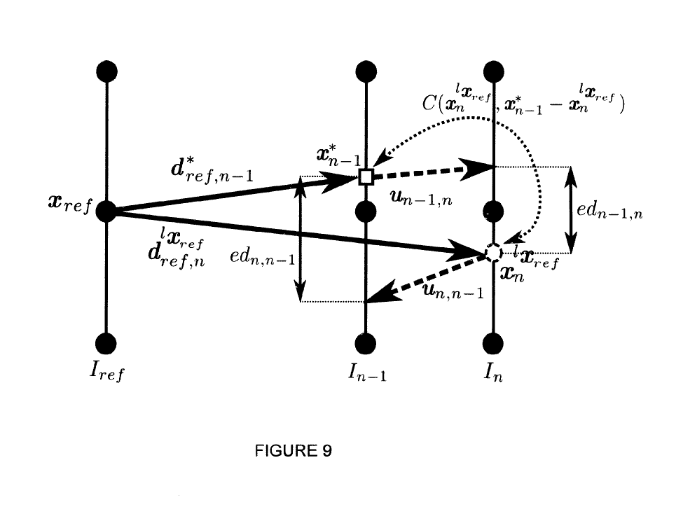

The temporal smoothness constraints translate in three new terms which are computed with respect to each neighbouring candidate x*ₘ defined for the frames inside the temporal window w. These terms are illustrated in FIG. 9 and deal more precisely with:
the matching cost between

$${x}_{n}^{{1}_{{x}_{ref}}} ∈ {I}_{n}$$

and x*ₘ of Iₘ,
the euclidean distance ed_{m,n} between

$${x}_{n}^{{1}_{{x}_{ref}}}$$

and the ending point of the elementary optical flow vector v_{m,n} starting from x*ₘ (see equation (17)). ed_{m,n} encourages the selection of xₙ^{m}, the candidate coming from the neighbouring frame Iₘ via the elementary optical flow field v_{m,n} and therefore tends to strengthen the temporal smoothness. Indeed, for xₙ^{m}, the euclidean distance ed_{m,n} is equal to 0.

$${ed}_{m , n} = {‖ ( {x}_{ref} + {d}_{ref , n}^{{1}_{{x}_{ref}}} ) - ( {x}_{ref} + {d}_{ref , m}^{*} + {v}_{m , n} ) ‖}_{2} \qquad ( 17 )$$

the euclidean distance ed_{n,m} between x*ₘ and the ending point of the elementary optical flow vector v_{n,m} starting from

$${x}_{n}^{{1}_{{x}_{ref}}}$$

(see equation (18)). If v_{m,n} is consistent, i.e. v_{m,n}≈v_{n,m}, ed_{n,m} is approximately equal to 0 which promotes again the selection of xₙ^{m}, the candidate coming from Iₘ.

$${ed}_{n , m} = {‖ ( {x}_{ref} + {d}_{ref , m}^{*} ) - ( {x}_{ref} + {d}_{ref , n}^{{1}_{{x}_{ref}}} + {v}_{n , m} ) ‖}_{2} \qquad ( 18 )$$

The regularization term E_{ref,n}^{r} involves motion similarities with neighbouring positions, as shown in equation (15). αₓ_{_{ref}}_{,y}_{_{ref}} accounts for local color similarities in the reference frame I_{ref}. The robust functions ρᵣ and ρ_{d} deal respectively with the Geman-McClure penalty function and the negative log of a Student-t distribution described by Lempitsky et˜al., in the article published in 2008 mentioned earlier.

Compared to the from-the-reference case, the energy for the refinement of to-the-reference displacement fields is similar except for the data term, equation (19), which involves neither the matching cost between the current candidate of the temporal neighbouring ones nor the euclidean distance ed_{m,n}. This is due to trajectories which can not be explicitly handled in this direction. Nevertheless, we compute the euclidean distance between the ending points of d*_{n,ref} starting from xₙ ∈ Iₙ and d*_{m,ref} concatenated to v_{n,m}.

$${ɛ}_{n , ref}^{d} = C ( {x}_{n} , {d}_{n , ref}^{{1}_{{x}_{n}}} ( {x}_{n} ) ) + Inc ( {x}_{n} , {d}_{n , ref}^{{1}_{{x}_{n}}} ( {x}_{n} ) ) + {\sum }_{{m = n - \frac{w}{2}}_{m \neq n}}^{n + \frac{w}{2}} {‖ ( {x}_{n} + {d}_{n , ref}^{{1}_{{x}_{n}}} ) - ( {x}_{n} + {v}_{n , m} + {d}_{m , ref}^{*} ) ‖}_{2} \qquad ( 19 )$$

The global optimization method fuses the displacement fields by pairs and therefore chooses to update or not the previous estimations with one of the previously described candidates. The motion refinement phase consists in applying this technique for each pair of frames {I_{ref},Iₙ} in from-the-reference and to-the-reference directions. The pairs {I_{ref},Iₙ} are processed in a random order in order to encourage temporal smoothness without introducing a sequential correlation between the resulting displacement fields.

This motion refinement phase is repeated iteratively Nᵢₜ times where one iteration corresponds to the processing of all the pairs {I_{ref},Iₙ}. The proposed statistical multi-step flow is done once the initial motion candidates generation and the Nᵢₜ iterations of motion refinement have been run through the sequence.

### Construction of Motion Candidates for Motion Estimation Between Distant Frames

We consider now the situation where input frames Iₐ and I_{b} are distant in the sequence (they are not adjacent). In the following, we will call these two frames “reference frames” (also corresponding to a pair of a current frame and a reference frame) to distinguish them from the other frames of the sequence. Depending on the displacement of the objects across the sequence, it often happens that direct estimation between such frames is difficult. An alternative consists in building motion vector candidates by concatenating or summing elementary motion fields that correspond to pairs of frames with smaller inter-frame distance (or step) and performing a statistical analysis.

A first solution to form a candidate consists in simply summing motion vectors of successive pairs of adjacent frames. If we call “step” the distance between two frames, step value is 1 for adjacent frames. We propose to extend this construction of motion candidates to the sum of motion vectors of pairs of frames that are not necessarily adjacent but remain reasonably distant so that this elementary motion field can be expected to be of good quality. This relies on the idea described in the international patent application PCT/EP13/050870 where motion estimation between a reference frame and the other frames of the sequence is carried out sequentially starting from the first frame adjacent to the reference frame. For each pair, multiple candidate motion fields are merged to form the output motion field. Each candidate motion field is built by summing an elementary input motion field and a previously estimated output motion field.

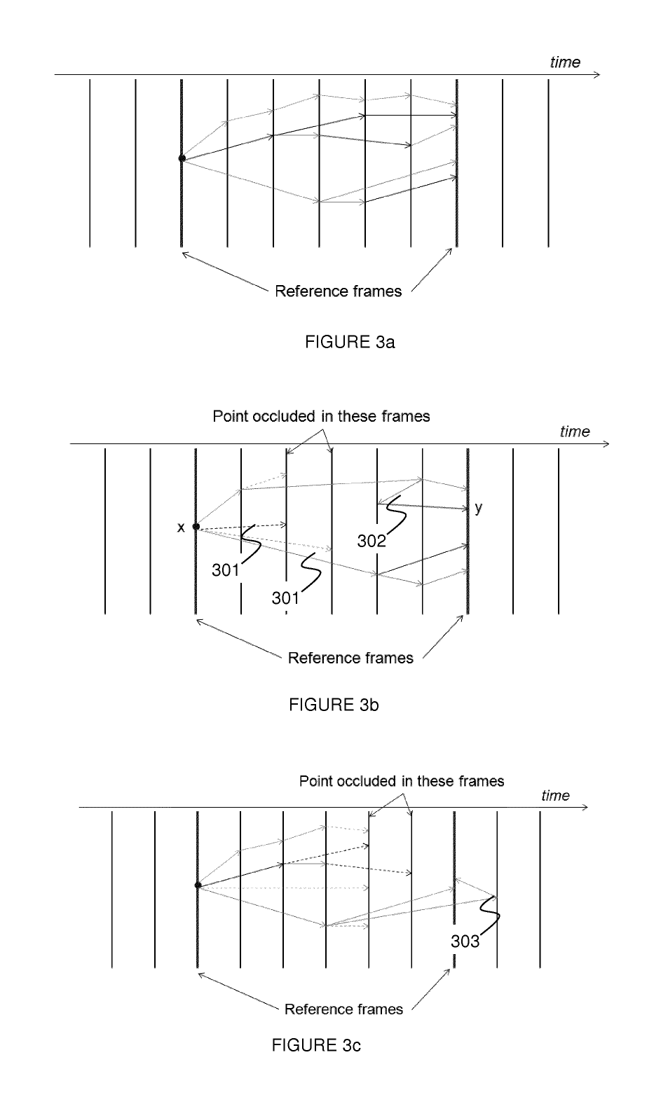

Here, we consider a pair of reference images and different candidates that join the two images. There is no sequential processing. The candidate motion fields are built by summing elementary motion fields with variable steps. Therefore, the number of candidate motion fields is variable. The elementary motion fields join pairs of frames in the interval delimited by the reference frames. FIG. 3a illustrates the concatenation of input elementary motion fields: it shows an example of a set of successive frames of a sequence where two reference frames, (or a current frame and a reference frame) are considered for inter-frame motion estimation. These frames are distant and good direct motion estimation is not available. In this case, elementary motion fields with smaller step values are considered (steps 1, 2 and 3 in FIG. 3a). The variability of the motion candidates is ensured by the multiple step values. The concatenation or sum of successive vectors leads to a vector that links the two reference frames. In the example of FIG. 2a, the pixel has 5 motion vector candidates. A first interest to consider multiple steps in concatenation is to build numerous different motion paths leading to numerous motion candidates. In addition, as highlighted in the international patent application PCT/EP13/050870, an interest of considering other steps rather than just step 1 is that it may allow linking points between two frames that are occluded in the intermediate frames.

Another version of motion concatenation consists in considering both forward and backward motion fields in the sum. This may have advantages in particular in case of occlusions. In the case that occlusion maps attached to the motion fields are available indicating whether a pixel is occluded or not in another frame, this information is used to possibly stop the construction of a path. FIG. 3b illustrates the case where point x visible in both reference frames is occluded in two intermediate frames. Numerous motion sums 301 are aborted. This reduces the number of possible motion candidates. It can be useful to introduce inverse vectors 302 to increase the number of possible combinations in order to propose additional motion candidates. As an example, the motion path that joins points x and y contains forward and backward elementary motion vectors.

For the same reasons, we can extend the motion candidate construction using elementary motion fields that join frames that are outside the interval delimited by the reference frames. FIG. 3c illustrates this case. The introduction of such additional motion fields allows compensating the break of motion concatenations due to occlusion.

We suppose that the elementary motion fields have been computed by at least one motion estimator applied to pairs of frames with various steps for example, steps are equal to 1, 2 or 3 as illustrated on FIG. 3a. We now present solutions to build candidate motion fields between two reference frames from a set of elementary motion fields corresponding to a set of given steps.

A first solution consists in considering all possible elementary motion fields of step values belonging to a selected set (for example steps equal to 1, 2 or 3) and linking frames of a predefined set of frames (for example all the frames located between the two reference frames plus these reference frames, but as seen above it could also include frames located outside this interval).

Formally, a motion path is obtained through concatenations or sums of elementary optical flow fields across the video sequence. It links each pixel xₐ of frame Iₐ to a corresponding position in frame I_{b}. Elementary optical flow fields can be computed between consecutive frames or with different frame steps, i.e. with larger inter-frame distances. Let Sₙ={s₁,s₂, . . . , s_{Q}_{ₙ}} be the set of Qₙ possible steps at instant n. This means that the set of optical flow fields {v_{n,n+s}_{₁},v_{n,n+s}_{₂}, . . . , v_{n,n+s}_{_{Qn}}} is available from any frame Iₙ of the sequence.

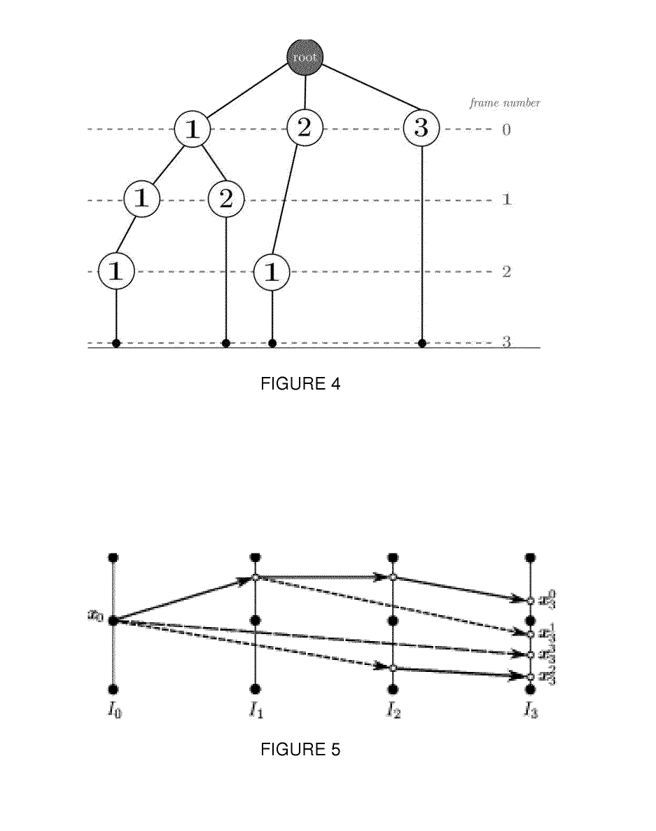

Our objective is to obtain a large set of motion paths and consequently a large set of candidate motion maps between Iₐ and I_{b}. Given this objective, we propose to initially generate all the possible step sequences (i.e. combinations of steps) in order to join I_{b} from Iₐ. Let Γ_{a,b}={γ₀, . . . , γ_{K-1}} be the set of K possible step sequences between Iₐ and I_{b}. Γ_{a,b} is computed by building a tree structure where each node corresponds to a motion field assigned to a given frame for a given step value (node value). In practice, the construction of the tree is done recursively: we create for each node as many children as the number of steps available at the current instant. A child node is not generated when I_{b} have already been reached (therefore, the current node is considered as a leaf node) or if I_{b} is overpassed given the considered step. Finally, once the tree has been completely created, going from the leaf nodes to the root node gives Γ_{a,b}, the set of step sequences. FIG. 4 illustrates an exhaustive generation of step sequences. In the tree, each node corresponds to a specific step available for a specific frame going from leaf nodes to root node gives Γ_{a,b}, the set of possible step sequences. With frame steps 1, 2 and 3, four step sequences can be computed between I₀ and I₃: Γ_{0,3}={γ₀,γ₁,γ₂,γ₃}={{1,1,1},{1,2},{2,1},{3}}. The skilled in the art will appreciate that motion paths have or do not have the same number of concatenated motion vectors. Once all the possible step sequences γᵢ ∀i ∈ [[0, . . . , K−1]] between Iₐ and I_{b} have been generated, the corresponding motion paths can be estimated through 1st-order Euler integration. Starting from each pixel xₐ of Iₐ and for each step sequence, this direct integration performs the accumulation of optical flow fields following the steps which form the current step sequence. FIG. 5 illustrates the construction of the four possible motion paths (one for each step sequence of Γ_{0,3}) between I₀ and I₃ with frame steps 1, 2 and 3. This gives for each pixel xₐ of Iₐ four corresponding positions in I_{b}. Let fⱼⁱ=Σₖ₌₀^{j}sₖⁱ be the current frame number during the construction of motion path i. For each step sequence γᵢ ∈ Γ_{a,b} and for each step sᵢ^{j} ∈ γᵢ, we start from xₐ to compute iteratively:

x_{a+f}_{ⱼ}_{ⁱ}=x_{a+f}_{_{j−1}}_{ⁱ}+v_{a+f}_{_{j−1}}_{ⁱ}_{,a+f}_{ⱼ}_{ⁱ}(x_{a+f}_{_{j−1}}_{ⁱ})

Once all the step sⱼⁱ ∈ γᵢ have been run through, we obtain x_{b}ⁱ, i.e. the corresponding positions in I_{b} of xₐ ∈ Iₐ obtained with step sequence γᵢ. Finally, at the end of the process, we have a large set of motion maps between Iₐ and I_{b} and consequently a large set of candidate positions in I_{b} for each pixel xₐ of Iₐ.

In the case that occlusion maps attached to the motion fields are available indicating whether a pixel is occluded or not in another frame, this information is used to possibly stop the construction of a path. Considering an intermediate point x_{a+f}_{ⱼ}_{ⁱ} during the construction of a path, and an elementary step to add to this path, if the closest pixel to point x_{a+f}_{ⱼ}_{ⁱ} is occluded at this step, then this current path is removed.

Another solution for the construction of multiple paths corresponds to a wider problem addressing the case of more distant reference frames and more steps than in the previous case. The problem will clearly appear with an example. Let us consider a distance of 30 between the reference frames and the following set of steps: 1, 2, 5 and 10. In this case, the number of possible paths using concatenation of elementary motion fields between the two reference frames is 5877241. Of course, all these paths cannot be considered and a different procedure must be introduced to select a reasonable number of paths.

According to an advantageous characteristic of motion path construction, a first constraint consists in limiting the number of elementary vectors composing the path. Actually, the concatenation of numerous vectors may lead to an important drift and more generally increases the noise level on the resulting vector. So, limiting the number of candidate vectors is reasonable.

According to another advantageous characteristic of motion path construction, a second constraint is imposed by the fact that the candidate vectors should be independent according to our assumption on the statistical processing. In fact, the frequency of appearance of a given step at a given frame should be uniform among all the possible steps arising from this frame in order to avoid a systematic bias towards the more populated branches of the tree. Practically, a problem would occur in particular if an erroneous elementary vector contributes several times to the construction of candidate vectors while the other correct vectors occur just once. In this case, the number of erroneous candidate vectors would be significant and would introduce a bias in the statistical processing.

So, the method consists in considering a maximum number of concatenations N_{c} for the motion paths. Secondly, once this constraint has been taken into account, we select randomly Nₛ motion paths (determined by storage capability). The random selection is guided by the second constraint above. Indeed, this second constraint ensures a certain independence of resulting candidate positions in I_{b}. In practice, for a given frame, each available step must lead to the same (or almost the same) number of step sequences. Each time we select a step sequence γᵢ, we increment the occurrence of each step sⱼⁱ ∈ γᵢ. Thus, the step sequence selection is done as follows. We run through the tree from root node. For a given frame, we choose the step of minimal occurrence, i.e. the step which has been less used than other steps defined for the current frame. If more than two steps return this minimum occurrence value, a random selection is performed between them. This selection of steps is repeated until a leaf node is reached.

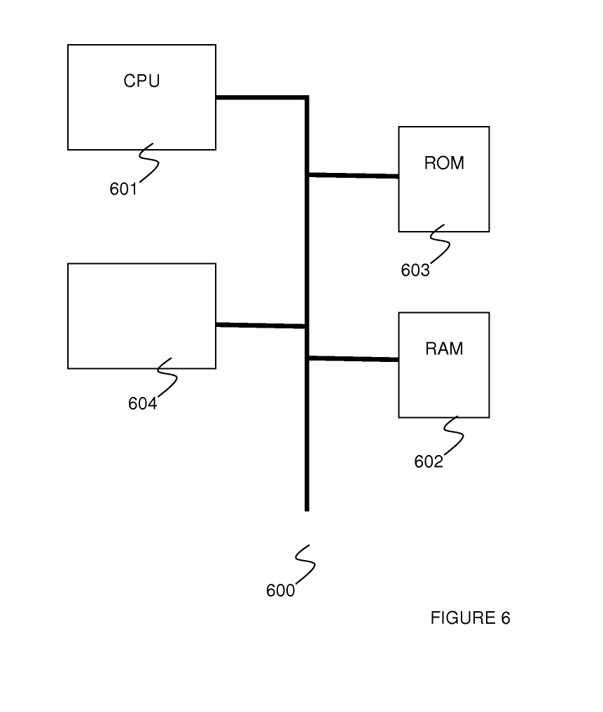

The skilled person will also appreciate that as the method can be implemented quite easily without the need for special equipment by devices such as PCs, mobile phone including or not graphic processing unit. According to different variant, features described for the method are being implemented in software module or in hardware module. FIG. 6 illustrates a device for generating a set of motion fields according to a particular embodiment of the invention. The device is, for instance, a computer at content provider or service provider. The device is, in a variant, any device intended to process video bit-stream. The device 600 comprises physical means intended to implement an embodiment of the invention, for instance a processor 601 (CPU or GPU), a data memory 602 (RAM, HDD), a program memory 603 (ROM) and a module 604 for implementation any of the function in hardware. Advantageously the data memory 602 stores the processed bit-stream representative of the video sequence, the input set of motion fields and the generated motion fields. The data memory 402 further stores candidate motion vectors before the selection step. Advantageously the processor 601 is configured to determine candidate motion vectors and select the optimal candidate motion vector trough a statistical processing. In a variant, the processor 601 is Graphic Processing Unit allowing parallel processing of the motion field generation method thus reducing the computation time. In another variant, the motion field generation method is implemented in a network cloud, i.e. in distributed processor connected through a network.

Each feature disclosed in the description and (where appropriate) the claims and drawings may be provided independently or in any appropriate combination. Features described as being implemented in software may also be implemented in hardware, and vice versa. Reference numerals appearing in the claims are by way of illustration only and shall have no limiting effect on the scope of the claims.

Naturally, the invention is not limited to the embodiments previously described. In particular, if the described method is dedicated to dense motion estimation between two frames, the invention is compatible with any method for generating motion field for sparse motion estimation. Thus, if statistical processing output is one motion vector per pixel and if global optimization is not considered, the system can be also applied to sparse motion estimation, i.e. statistical processing is applied to motion candidates assigned to any particular point in the current image.

1-18. (canceled)

19. A method for generating a motion field between a current frame and a reference frame belonging to a video sequence from an input set of motion fields; the method comprising:
determining, for a group of pixels belonging to said current frame, a motion vector from said current frame to said reference frame wherein said motion vector is the result of a sum of motion vectors; each motion vector of said sum belonging to an input motion field according to a determined motion path; a motion path comprising a sequence of N ordered pairs of frames associated to said input set of motion fields wherein N is an integer and wherein the N ordered pairs of frames are randomly selected.

20. The method according to claim 19 wherein said integer N of ordered pairs of frames in determined motion paths is smaller than a threshold.

21. The method according to claim 19 wherein a second frame of the previous ordered pair in the sequence is temporally placed before or after a first frame of the ordered pair.

22. The method according to claim 19 wherein a first frame of an ordered pair is temporally placed before the current frame or after the reference frame.

23. The method according to claim 19 wherein determining a motion vector comprising minimizing a metric for the motion vector among results of a sum of motion vectors; said metric comprises Euclidian distance between endpoints location or Euclidian distance between color gain vectors; an endpoint location resulting from a motion vector and; color gain vectors being computed between color vectors of a local neighborhood of said endpoint location and color vectors of a local neighborhood of said current pixel belonging to said current frame.

24. The method according to claim 23 further comprising:
a) for each motion vector, computing each Euclidian distance between a endpoint location resulting from said determined motion vector and each of other endpoints location resulting from other motion vectors;
b) for each determined motion vector, computing a median for said computed Euclidian distances;
c) selecting the motion vector for which the median of computed Euclidian distance is the smallest.

25. The method according to claim 24 further comprising, for each determined motion vector, counting the Euclidian distance a number of times representative of a confidence score of said endpoint location resulting from said determined motion vector.

26. The method according to claim 23 further comprising:
d) for each motion vector, computing Euclidian distance between color gain vectors of a local neighborhood of endpoint location and color gain vectors of a local neighborhood current pixel of a current frame; an endpoint resulting from said motion vector;
e) for each motion vector, computing a median for said computed Euclidian distance between color gain vectors;
f) selecting the motion vector for which the median is the smallest.

27. The method according to claim 26 wherein between step d) and step e), a step further comprises, for each motion vector, counting the Euclidian distance between color gain vectors a number of times representative of a confidence score of endpoint location resulting from said motion vector.

28. The method according to claim 24, wherein selecting step c) or f) are repeated on a subset of motion vectors resulting in a subset of determined motion vectors for which the median is the smallest and is followed by a global optimization process on said subset of motion vectors in order to select for each current pixel of the current frame the best vector with respect to minimization of a global energy.

29. The method according to claim 19 wherein the method is repeated for a plurality of current frame belonging to the neighbouring of current frame.

30. The method according to claim 19 wherein the generated motion field is used as input set of motion field for iteratively generating a new motion field.

31. A device for generating a motion field between a current frame and a reference frame belonging to a video sequence from an input set of motion fields; the device comprising a processor configured to:
determine, for a group of pixels belonging to said current frame, a motion vector from said current frame to said reference frame wherein said motion vector is the result of a sum of motion vectors; each motion vector of said sum belonging to an input motion field according to a determined motion path; a motion path comprising a sequence of N ordered pairs of frames associated to said input set of motion fields wherein N is an integer and wherein the N ordered pairs of frames are randomly selected.

32. The device according to claim 31 wherein said integer N of ordered pairs of frames in determined motion paths is smaller than a threshold.

33. The device according to claim 31 wherein a second frame of the previous ordered pair in the sequence is temporally placed before or after a first frame of the ordered pair.

34. The device according to claim 31 wherein a first frame of an ordered pair is temporally placed before the current frame or after the reference frame.

35. The device according to claim 31 wherein the processor is configured to minimize a metric for the determined motion vector among the sums of motion vectors; said metric comprises Euclidian distance between endpoints location or Euclidian distance between color gain vectors; an endpoint location resulting from a motion vector and; color gain vectors being computed between color vectors of a local neighborhood of said endpoint location and color vectors of a local neighborhood of said current pixel belonging to said current frame.

36. The device according to claim 35 wherein the processor is configured to:
a) for each motion vector, compute an Euclidian distance between an endpoint location resulting from said determined motion vector and each of other endpoints location resulting from other motion vectors;
b) for each determined motion vector, computing a median for said computed Euclidian distances;
c) selecting the motion vector for which the median of computed Euclidian distance is the smallest.

37. The device according to claim 36 wherein the processor is configured to, for each determined motion vector, count the Euclidian distance a number of times representative of a confidence score of said endpoint location resulting from said determined motion vector.

38. The device according to claim 35 wherein the processor is configured to:
d) for each motion vector, compute Euclidian distance between color gain vectors of a local neighborhood of endpoint location and color gain vectors of a local neighborhood current pixel of a current frame; an endpoint resulting from said motion vector;
e) for each motion vector, compute a median for said computed Euclidian distance between color gain vectors;
f) select the motion vector for which the median is the smallest.

39. The device according to claim 38, wherein the processor is configured, for each motion vector, to count the Euclidian distance between color gain vectors a number of times representative of a confidence score of endpoint location resulting from said motion vector.

40. The device according to claim 36, wherein wherein the processor is configured to repeat the selection on a subset of motion vectors resulting in a subset of determined motion vectors for which the median is the smallest and is configured to apply a global optimization process on said subset of motion vectors in order to select for each current pixel of the current frame the best vector with respect to minimization of a global energy.

41. The device according to claim 31 wherein the processor is configured to repeat the determination for a plurality of current frame belonging to the neighbouring of current frame.

42. The device according to claim 31 wherein the processor is configured to use the generated motion field as input set of motion field for iteratively generating a new motion field.

43. A computer program product stored in a non-transitory computer-readable storage media, comprising computer-executable instructions for determining, for a group of pixels belonging to said current frame, a motion vector from said current frame to said reference frame wherein said motion vector is the result of a sum of motion vectors; each motion vector of said sum belonging to an input motion field according to a determined motion path; a motion path comprising a sequence of N ordered pairs of frames associated to said input set of motion fields wherein N is an integer and wherein the N ordered pairs of frames are randomly selected.
